(19) United States
(12) Patent Application Publication
(10) Pub. No.: US 2026/0208201 A1
(43) Pub. Date: Jul. 23, 2026

(54) METHOD AND IMPACT CRUSHER FOR REDUCING THE SIZE OF MINERAL PARTICLES BY IMPACT

(71) Applicant: PF Innovation B.V., Dordrecht (NL)

(72) Inventors: Christiaan Jacobus Van Roosendaal, Dordrecht (NL); Sebastiaan Ooms, Dordrecht (NL)

(21) Appl. No.: 19/157,770

(22) PCT Filed: Feb. 23, 2024
(86) PCT No.: PCT/EP2024/054676

§ 371 Date: Aug. 19, 2025

(30) Foreign Application Priority Data
Feb. 23, 2023 (NL) 2034205
Aug. 24, 2023 (NL) 2035669

(51) Int. Cl. B02C 13/18; B02C 23/20

(52) U.S. Cl. CPC B02C 13/1807; B02C 23/20; B02C 2013/1857

(57) ABSTRACT

An includes a housing provided a rotatable inner rotor having a central axis and a rotatable outer rotor provided coaxial with the inner rotor and including a circumferential wall having an impact section. A discharge space is provided between the outer rotor and an inner surface of the housing. Mineral particles are supplied to the inner rotor while the inner and outer rotor counter rotate around the central axis, and the mineral particles are displaced over the inner rotor under the influence of a centrifugal force. The mineral particles are then flung from the inner rotor in a tangential direction towards the impact section of the outer rotor for reducing the size of the mineral particles upon impact to obtain impact reduced mineral particles, and discharged from the outer rotor to the discharge space by removing the impact-reduced mineral particles from the outer rotor.

### CROSS-REFERENCE TO RELATED APPLICATIONS

This application is the National Stage of International Application No. PCT/EP2024/054676, filed Feb. 23, 2024, which claims the benefit of Netherlands Application Nos. 2034205, filed Feb. 23, 2023, and U.S. Pat. No. 2,035,669, filed, Aug. 24, 2023, the contents of all of which is incorporated by reference herein.

### FIELD OF THE INVENTION

The present invention relates to a method and impact crusher for reducing the size of sand particles by impact.

### BACKGROUND OF THE INVENTION

Fine grain mineral particles, such as fine grain sand, are used for a variety of applications, such as self-levelling mortar and concrete. The use of this fine grain sand prevents shrinkage cracks in the mortars and concrete when drying by having filling in voids left by coarser aggregates. Sand that is naturally fine can be used directly in these products. Alternatively however, fine sand particles may be obtained by reducing sand mechanically.

Mechanical reduction of sand can be achieved for example with impact crushers. Impact crushers generally have a fast spinning inner rotor that throws the material to be reduced against a solid (stationary) impact wall. The striking and impacting causes the material to be reduced in size.

Such an impact crusher is known from for example NL1000111C. NL1000111C discloses a double activated autogenous impact crusher for crushing granulated material. The impact breaker has two disc-shaped rotor vanes rotating about a vertical axis in opposite directions. under the influence of a centrifugal force, grain material is thrown off the rotor vanes. The material is thrown into a trough in which it accumulates to form a belt. Because the pellets are guided into the trough from two directions, the impact with which the granulated material strikes the trough is increased. The reduced particles that are obtained herewith have a rounded grain configuration and a hard grain surface.

Another device is known from JPH02122842, which discloses a vertical impact crusher used for polishing and reducing aggregates for concrete. JPH02122842 mentions that artificial aggregates for civil engineering construction use primary crushed rocks that have many sharp points. This is undesirable, as the use of this sharp-edged aggregate results in a lower strength of the concrete. To obtain the same strength more cement is therefore required.

The vertical impact crusher according to JPH02122842 has an inner rotor and an outer rotor that are provided in a housing and rotate in counter directions. The material to be crushed is introduced from a feed opening into the inner rotor. During rotation of the inner rotor, the material is flung from the inner rotor onto a vertical wall of the outer rotor where it accumulates. Accumulated material is then discharged from the outer rotor through an annularly-shaped bottom recess in the outer rotor or by dropping through a central opening.

A disadvantage of the known devices is that that these are insufficiently capable of reducing the grain size of the material to below a desired threshold level, and especially for reducing the grain size of sand particles.

Another disadvantage thereof is that the annularly-shaped recess is only capable of discharging a limited amount of material. As a result, there's a higher chance that the crushed particles may accumulate and block the flow of material through the crusher, especially during high-throughput operations or when processing materials with irregular shapes or sizes. This accumulation can lead to a range of issues, including decreased efficiency, increased wear on internal components, and even mechanical failure if the congestion is severe.

### DESCRIPTION OF THE INVENTION

The present invention aims to overcome those disadvantages at least partly or to provide a usable alternative. In particular the present invention aims to provide a method for reducing the grain size and the size distribution of mineral particles.

In a first aspect, the present invention provides a method for reducing the size of mineral particles, comprising the steps of
providing an impact crusher comprising a housing with therein provided a rotatable inner rotor having a central axis and a rotatable outer rotor provided coaxial with the inner rotor, the outer rotor comprising a circumferential wall having an impact section, wherein a discharge space is provided between the outer rotor and an inner surface of the housing;
supplying mineral particles to the inner rotor while the inner and outer rotor counter-rotate around the central axis;
displacing the mineral particles over the inner rotor under the influence of a centrifugal force and flinging of the displaced mineral particles from the inner rotor in a tangential direction towards the impact section of the outer rotor for reducing the size of the mineral particles upon impact with the impact section, thereby obtaining impact reduced mineral particles, and
discharging the impact-reduced mineral particles from the outer rotor to the discharge space,
characterized in that the step of discharging the impact-reduced mineral particles to the discharge space comprises removing the impact-reduced mineral particles from the outer rotor along opposite axial sides of the impact section of the circumferential wall.

In a second aspect the present invention relates to a mineral particle impact crusher for reducing the size of mineral particles, comprising
a rotatable inner rotor having a central axis;
a rotatable outer rotor provided coaxial with the inner rotor and comprising a circumferential wall having an impact section, wherein the inner and outer rotor are configured for during use counter-rotating around the central axis;
a housing with therein provided the inner and outer rotor and having a discharge space between an inner surface of the housing and the outer rotor, and
a mineral particle supply configured for supplying mineral particles to the inner rotor;
wherein the inner rotor is configured for during use flinging supplied mineral particles in a tangential direction from the inner rotor to the impact section of the counter-rotating outer rotor for reducing the size of the mineral particles upon impact,
characterized in that the outer rotor is configured for during use discharging the impact-reduced mineral particles from the outer rotor to the discharge space along opposite axial sides of the impact section of the circumferential wall.

The method and impact crusher according to the invention allow mineral particles to be efficiently reduced to very small sizes. Any type of mineral or mixtures of minerals may be reduced in size by the invention. One type of mineral that has been shown to be particularly suitable for size reduction with the invention is sand, such as silver sand, which is a fine white sand which consists largely of quartz particles. The sand may be obtained through sand mining. Quartz is a common mineral found in many rocks and is one of the most abundant minerals on Earth. It is composed of silicon and oxygen atoms, with the chemical formula SiO2. Larger mineral particles, such as gravel, may however also be effectively reduced in size by the method and impact crusher according to the invention.

The method according to the invention comprises supplying the mineral particles to be reduced to a rotatable inner rotor having a central axis that is configured to rotate in a first rotation direction. The mineral particles may be supplied from a mineral storage that is present on the impact crusher, or that is spaced away from the impact crusher and connected to the impact crusher via suitable transport lines. The mineral particles are preferably transported continuously to the impact crusher. This may be achieved by suitable transportation means, such as screw, belt or bucket conveyers.

The impact crusher comprises a housing with therein provided an inner rotor and an outer rotor. A discharge space is present between the outer rotor and the inner surface of the housing. The inner and outer rotor are arranged coaxial around the central axis of the inner rotor. This central axis is preferably a vertical axis. It is however possible that the central axis is a non-vertical central axis, such as a horizontal axis. When the mineral particles are supplied to the impact crusher, the mineral particles are placed, preferably dropped, on the inner rotor, in particular at the centre of the inner rotor. When having an impact crusher rotating around a vertical axis, preferably gravity is used to vertically deposit the mineral particles onto the inner rotor. The inner rotor may be formed by a rotatable plate, preferably having a circular circumference, that comprises a substantially flat distribution surface. When the inner rotor rotates, the mineral particles on the inner rotor are directed outwardly, thereby displacing over the distribution surface, towards an outer edge of the inner rotor under the influence of a centrifugal force. When the particles have reached the outer edge, the mineral particles are flung from the outer edge of the inner rotor in a tangential direction. As the mineral particles reach the outer edge of the inner rotor, they are subjected to the highest centrifugal force. At this point, the force acting on the particles is perpendicular to the radius of the rotor, resulting in a rapid flinging or throwing motion in a tangential direction. As a result, the mineral particles are propelled outward from the inner rotor, following a path that is parallel to the plane of rotation.

The inner rotor may be driven in rotation by a first drive. This first drive may be any kind of rotational drive known to the skilled person, such as an electromotor.

After flinging of the mineral particles, said mineral particles impact the outer rotor. The outer rotor is configured to rotate in a second rotation direction opposite to the first rotation direction. The outer rotor is provided surrounding at least a part of the inner rotor, but preferably surrounding the entire circumference of the inner rotor. The outer rotor has a circumferential wall comprising an impact section. Mineral particles that are flung from the inner rotor impact the circumferential wall of the outer rotor at said impact section. The impact section therefore refers to the area or region on the circumferential wall of the outer rotor where the material from the inner rotor makes contact and interacts with the outer rotor, and wherein the collision between the material and the outer rotor occurs. In between the inner rotor and the impact section of the outer rotor, an impact space is present. This impact space is where the mineral particles undergo high-velocity collisions with each other.

The outer rotor is driven in rotation by the first drive or by a second drive that is different from the first drive. This second drive may be any kind of rotational drive known to the skilled person, such as an electromotor.

During the rotation of the inner rotor in the first direction, the mineral particles are flung outward and collide with the impact section of the circumferential wall of the outer rotor, which counter rotates relative to the inner rotor. As a result of this collision, some of the flung mineral particles may accumulate on the circumferential wall, forming a layer or belt of mineral particles on at least the impact section. The centrifugal force plays a role in the formation of this impact belt, as it propels the mineral particles outward. The counter rotation of the outer rotor, in the opposite direction to the inner rotor, further facilitates the deposition of the mineral particles on its surface, contributing to the build-up of the impact belt. The presence of the impact belt may enhance the effectiveness of the size reduction process, as it increases the chances of further collisions between the mineral particles and the impact section of the circumferential wall during subsequent rotations.

During rotation of the inner rotor, there will be a continuous flow of mineral particles that undergo size reduction upon impact. To prevent the rotors from jamming, these impact-reduced mineral particles need to be removed from the space between the rotors, or the impact space. According to the inventive thought, the impact reduced mineral particles are discharged from the outer rotor to the discharge space by removing impact reduced mineral particles from the outer rotor along opposite axial sides of the impact section. This implies that, in the scenario of a vertical central axis, the particles may exit or be removed from both above and below the impact section of the outer rotor. Conversely, for e.g. a horizontal central axis, the particles may be removed from both the left and right sides of the impact section of the rotor.

It is for example possible to rotate the circumferential wall of the outer rotor itself while both axial ends of the circumferential wall are entirely or partially open. This allows impact reduced mineral particles to be removed from the outer rotor through both axial ends out of the outer rotor, into the discharge space between the outer rotor and the housing. It is also possible to place on one or both axial sides of the outer rotor an apertured cover or shield such that impact reduced mineral particles may be discharged from the outer rotor through the apertures. The apertures in the cover or shield may then be positioned axially or inclined relative to the central axis, or the apertures may be positioned radially at one or both sides of the impact section.

Optionally and preferably, the outer rotor comprises an apertured cover or shield on one axial side of the circumferential wall while having an open axial side opposite of the cover. In particular, when the impact crusher is a vertical impact crusher having a vertical central axis, the outer rotor comprises an apertured cover or shield on an upper part of the circumferential wall and comprises an open bottom at a lower part of the circumferential wall. Alternatively, an apertured cover or shield may be provided on both axial sides of the circumferential wall.

Optionally and preferably, during use, the outer rotor is driven in rotation through the cover or shield. The outer rotor may e.g. be a rotatable drum having multiple apertures that is axially driven in rotation. The rotatable drum preferably also comprises a central opening through which mineral particles are supplied to the inner rotor.

An advantage of removing the impact-reduced mineral particles along both axial sides of the impact section is that the impact reduced mineral particles are removed more efficiently from the outer rotor, which allows the impact crusher to operate at higher speeds and/or handle a greater volume of material without the risk of clogging or jamming. With higher rotational speeds, the velocity at which the particles are thrown towards the impact section is increased, resulting in a more powerful impact and, consequently, improved particle size reduction. It has even been observed by the inventors that the mineral particles that are obtained with the invention have a sharp and edgy surface area, which can be explained by the very large impact forces that may be the result of the two-sided removal that shatter the mineral particles. The high impact forces may shatter the mineral particles, creating irregular and jagged surfaces with sharp edges. Moreover, it is hypothesized that the fast removal of the impact reduced mineral particles, which may also be attributed to the two-sided removal and the higher throughput of material, prevents the smoothening of the rough surfaces caused by impact.

In addition, the two-sided particle removal from the outer rotor prevents accumulation of material between the rotors. As a result, the reliability and longevity of the impact crusher may be improved, downtime for maintenance may be reduced and the overall productivity may be increased.

It has also surprisingly been found by the inventors of the present invention that the impact reduced mineral particles obtained with the invention have unexpected properties when used in a variety of applications, amongst others in self-levelling compounds, mortar, concrete and the cultivation of plants and produce. When used in self-levelling compounds, such as self-levelling mortar, mortar and concrete, the impact reduced mineral particles for example enhances the adhesion of the self-levelling mortar to a surface, is more stable and crimps less after drying. It has moreover been found that over 50% of the self-levelling mortar may be replaced by the impact reduced sand without affecting the performance of the mixture. The amount of cement in a mixture can thus be significantly reduced. As cement is known for its high CO₂ emissions, a reduction of the required cement therefore means a reduction in CO₂ emissions as well. In self-levelling mortar, it has been found that the use of mineral obtained with the method according to the invention initially provides a low viscosity self-levelling mortar that thickens after a certain amount of time.

Moreover, the use of the impact reduced mineral particles in the soil shows surprising effects on the growth of plants and produce, both when the impact reduced mineral particles are used as a replacement of fertilizer as well as when it is used in addition to fertilizer. Test results have shown that the mineral provides enhanced uptake of nutrients by the roots of plants, and that the mineral attracts more moisture into the soil.

Some of these effects can be partially explained by the size reduction of the mineral particles: because of the size reduction of the mineral particles, with which the mineral particles have obtained a sharp and edgy surface area, which prevents the leaching of sand and improves the aeration of the soil.

But the effects are so great and unexpected that it is questioned by the inventors whether the reduction in grain size is the only explanation for the surprising effects. Based on test results, that are also provided in the experimental section, it is hypothesized that during impact of the mineral particles not only the grain size of the particles is reduced, but the chemical composition and/or the crystal structure may be altered as well.

In particular it is hypothesized that during the crushing of the mineral particles, the mineral particles are mechanochemically activated. Mark Stillings (The mechanochemical processing of silicate rocks to trap CO₂, 2023, Nature Sustainability) has proposed a new theory of CO₂ and N₂ adsorption onto the mineral surface as a result of mechanochemical surface activation. The mechanochemical activation of minerals may occur as a result of impact induced deformation in the crystal lattice of the minerals. As a consequence of this deformation, dislocations within the lattice migrate to the mineral surface, resulting in the generation of charged species. Fracturing of the mineral can lead to bond breakages, causing a localized increase in temperature and the formation of surface radicals. This process also releases charged silica and oxygen.

It is therefore believed by the inventors that the method according to the invention is a method for the mechanochemical surface activation of mineral particles, and that the impact crusher according to the invention is a mineral particle impact crusher for the mechanochemical surface activation of mineral particles.

An alternative hypothesis may be that, after impact, the mineral particles have obtained a porous structure. The mineral particles may for example have been converted to a zeolite. The porous structure of the mineral particles explain the increased absorption of water in the mortar and concrete, and in the soil of the potato fields.

Another phenomenon that is observed is that mineral particles, in particular sand particles, exhibit a lighter color after reduction upon impact. This could potentially imply that the particles have undergone a chemical reaction, such as the formation of a carbonate during impact.

In an embodiment of the invention, the method further comprises a step of separating a first mineral fraction of mineral particles with an average particle size and/or below a first threshold value from a second mineral fraction of mineral particles with an average particle size and/or weight above the first threshold value. The first mineral fraction may be removed from the discharge space in the housing and collected in e.g. a vessel or a container. This first mineral fraction may then be used for a variety of applications. The average grain size and optionally also the grain size distribution of the mineral particles of this first mineral fraction is significantly smaller than the average grain size and optionally also the grain size distribution of the combined first and second mineral fraction. An advantage of separating the first and second mineral fraction is that the surprising effects in e.g. self-leveling mortar as mentioned above are further enhanced when having a larger proportion of smaller impact reduced particles within the final product.

A separation mechanism may be provided for separating the first and second mineral fraction. The separation mechanism may for example be configured for sucking the first mineral fraction from the housing (in particular, the discharge space) and for simultaneously drawing a fluid, in particular air, into the housing. Preferably an extractor is provided with which the mineral particles of the first mineral fraction are sucked away. This advantageously allows the extraction of the first mineral fraction, while the mineral particles of the second mineral fraction are too heavy to be sucked away. The first mineral fraction is preferably sucked out through an opening at an upper part of the housing.

To draw in a fluid, the housing may e.g. be provided with an opening in the housing, in particular at a lower part of the housing, for during use drawing the fluid into the housing. This opening may be the same opening through which the second mineral fraction is removed from the housing. Optionally, louver slots may be provided at said opening.

Having an opening at an upper part of the housing for sucking the first mineral fraction, and an opening at a lower part of the housing for drawing in the fluid provides a fluid flow through the housing during use. Alternatively or additionally, a separate opening for extracting the fluid from the housing, which is not used for sucking the first mineral fraction, may be provided in the housing.

As a result of extracting fluid from the housing while simultaneously drawing in a fluid into the housing, there is a constant stream of fluid into and out of the housing. This provides several advantages. For example, when air flows through the housing, there is a constant presence of water, N₂ and CO₂ around the mineral particles that are reduced upon impact. The water, N₂ and/or CO₂ may play a role in the mechanochemical activation of the surface of the mineral particles. It is furthermore hypothesized by the inventors that, due to the rotation of the rotors, the components in air are also partially separated, with the heaviest components (e.g. CO₂) moving towards the impact section under the influence of a centrifugal force. This causes a higher concentration of for example CO₂ at said impact section of the outer rotor, which may further improve the mechanochemical surface activation.

Additionally or alternatively to air, other fluids may be drawn into the housing, such as (pure) CO₂ or N₂, or mixtures thereof.

The second mineral fraction is preferably also collected. This second mineral fraction comprises relatively large mineral particles compared to the first mineral fraction. This second mineral fraction is therefore preferably collected at the bottom of the housing by means of gravity. Here, the particles can be gathered and, if necessary, removed from the housing. Removal may be achieved through an opening in a lower part of the housing. After removal this second mineral fraction may be recycled to the supply of the impact crusher for further size reduction.

In an embodiment of the invention, the method further comprises separating the first mineral fraction in a third mineral fraction having an third average particle size and/or weight below a second threshold value and a fourth mineral fraction having a fourth average particle size and/or weight above said second threshold value. Due to this second separation step, the obtained third mineral fraction has a smaller particle size distribution compared to the first mineral fraction, and the average particle size is smaller. For this second separation step known devices may be used, such as an air classifier. The fourth mineral fraction is preferably recirculated to the inner rotor for further size reduction.

In an embodiment of the invention, the mineral particles may be dried before being supplied to the inner rotor, in particular using heated air. A low water content in mineral particles, and in particular in sand, may help prevent clogging of e.g. transportation means during material transportation and the components of the impact crusher. Drier sand tends to flow more smoothly and move more freely, making it easier to be conveyed through pipelines, funnels, or other transportation means without getting stuck. A drying system may be present to ensure the mineral particles are dried to the desired level, which is preferably to a water content in the mineral particles of less than 1%, and preferably less than 0.1%. Even more preferably no measurable water is present in the mineral particles. The drying system may comprise a screw conveyer that is configured for simultaneously conveying and drying the sand.

In an embodiment of the invention, the housing may have a polygonal shape, such as a square shape, in cross-section. The rotation of rotors generates a flow inside a housing. This flow creates low-pressure areas in the corners, causing relatively large impact-reduced particles to move and accumulate there due to the influence of centrifugal force. Because of the low-pressure areas formed in the corners of the housing, the larger particles that have gathered there will tend to stay in those regions. The low pressure acts as a sort of trap, keeping these particles localized. This characteristic may be beneficial because it makes it easier to separate these larger particles from the smaller particles in the system.

In an embodiment of the invention, vanes are provided on the inner rotor. The vanes allow the mineral particles to be moved over the inner rotor in a controlled way. These vanes may have a variety of shapes, such as curved or they may be straight. It is however preferred that the vanes have an angled shape. The vanes' angled shape means that they are not straight but have a sloped or beveled profile, creating a tilted surface rather than a flat one. Each vane may for example have one angle, forming a single corner, or two angles, resulting in two corners within the vane's structure. Having angled vanes allow sand to build op at the corners of the vanes, which prevent wear and tear of the vanes during use. Consequently, the vanes experience reduced wear and tear during use, promoting longer service life and lower maintenance requirements for the impact crusher. In addition, the accumulation of sand gives an initial reduction of the sand as it moves along the built-up layer in the vanes. As the sand moves along the built-up layer on the vanes, it undergoes a crushing action against itself and the vane surface. This localized impact leads to some sand particles breaking and fracturing, contributing to the overall size reduction process. This initial reduction of sand particles prepares them for further crushing and pulverization as they are flung from the outer edge of the inner rotor.

In an embodiment of the invention, the mineral particles are flung from the inner rotor with a velocity of at least 40 m/s, preferably at least 55 m/s, more preferably at least 70 m/s. Due to this high velocity the mineral particles strike the impact section with great force, thereby reducing the size of the mineral particles. Higher velocities provide a better overall size reduction, which increases the efficiency of the process and requires less recirculation of mineral particles that have a size above a certain average particles size threshold.

In an embodiment of the invention, the inner rotor rotates with a velocity of at least 2000 rpm, preferably 2500 rpm, and more preferably 3000 rpm. The impact may be insufficient at lower speeds. Additionally or alternatively, the inner rotor and the outer rotor may rotate in counter-rotation directions with a velocity difference of at least 4000 rpm, preferably at least 5000 rpm, and more preferably at least 6000 rpm. This large difference in velocity further increases the impact force of the mineral particles onto the impact section of the circumferential wall. Optionally, the inner and outer rotor rotate with a similar velocity in opposite directions. For example, when the velocity difference between the inner and outer rotor is 6000 rpm, the inner rotor preferably rotates with approximately 3000 rpm in the first rotation direction, while the outer rotor rotates with approximately 3000 rpm in the second rotation direction. This allows the greatest impact force in the most efficient manner. A significant difference in rotational speeds between the outer and inner rotors may pose problems. If the outer rotor rotates at a much higher speed, it may cause the layer thickness on the impact section to become too thick, resulting in possible rotor-to-rotor friction. On the other hand, if the rotor turns too slowly, the achieved impact may not be sufficient. The outer rotor therefore preferably rotates with a velocity of at least 2000 rpm, preferably 2500 rpm, and more preferably 3000 rpm.

In an embodiment of the invention, an inwardly extending protrusion may be provided on a lower end of the circumferential wall. This inwardly extending protrusion may act as a barrier to prevent the mineral particles from falling down the circumferential wall, ensuring their accumulation and the formation of the mineral particle layer. The impact belt may form a protective layer on the circumferential wall's surface. Instead of the mineral particles directly contacting the impact section, they interact with the impact belt first. This protective layer acts as a barrier, shielding the impact section from direct contact with the abrasive and potentially damaging mineral particles. As a result, the impact belt bears the brunt of the wear, preserving the circumferential wall's structural integrity and prolonging its lifespan. In addition, the presence of the impact belt may help distribute the wear more evenly across the surface of the circumferential wall. Instead of localized wear in specific spots, the wear is distributed over a broader area of the circumferential wall due to the continuous movement of the mineral particles within the impact belt. This even wear distribution can help prevent the formation of concentrated wear spots that could lead to premature failure of the circumferential wall. Another advantage of the impact belt is that the belt allows the mineral particles to be even further reduced in size, as the mineral particles collected in the belt receive the impact forces of the mineral particles that are flung from the inner rotor.

In an embodiment, a dosing system may be provided on the impact crusher, such as a silo or a silo bin. The dosing system may guide mineral particles into the housing of the impact crusher, in particular to the inner rotor. The dosing system preferably comprises a mineral supply tube through which mineral particles may fall onto the inner rotor under the influence of gravity (in the case of a vertical central axis). Feeding of the mineral particles from a mineral storage to the dosing system may be done using varies types of transportation or conveyer means, such as screw, belt or bucket conveyers. By incorporating such a dosing system, the impact crusher can operate with a more consistent and regulated input of mineral particles, which may enhance overall performance, efficiency, and reliability of the crushing process. Additionally, it helps in optimizing the utilization of the crusher's capacity by ensuring a steady supply of material, reducing the likelihood of overloading or underfeeding the crusher.

In a third aspect, the invention relates to the use of impact reduced mineral particles, and in particular impact reduced sand particles, in a variety of applications. The impact reduced mineral particles are for example used in growing/culturing vegetables, plants, as soil improvement agent, in cementitious products, such as concrete or levelling compounds, glass products, quartz products, LCD-screens or cosmetic products.

### EXPERIMENTAL

### Method for Reducing the Size of Mineral Particles

A feed stock of mineral particles, in particular silver sand particles, is provided for the experiments. The sand particles are fed to an impact crusher according to the invention. In the impact crusher, sand particles are deposited on an inner rotor that rotates with 3000 rpm in a first rotation direction around a vertical axis. During rotation of the inner rotor, a centrifugal force moves the deposited sand particles from the centre part of the inner rotor towards the outer edge of the inner rotor. As the sand particles moves towards the outer edge of the inner rotor, the sand particles are guided along vanes. When sand particles have reached the outer edge of the inner rotor, the particles are flung from the inner rotor in a tangential direction under the influence of a centrifugal force. The flung sand particles hit the impact section of the circumferential wall of then outer rotor that is coaxial with the inner rotor and rotates with 3000 rpm in a second rotation direction opposite to the first rotation direction. Because of the counter-rotation of the outer rotor, a layer of flung sand builds up on the circumferential wall. This layer of sand particles improves the size reduction of the sand particles while at the same time preventing the collecting drum from wearing out. The impact reduced sand particles are removed from the outer rotor along two axial sides of the outer rotor.

It has been calculated that the speed with which the sand is flung from the inner rotor is approximately 70 m/s. Due to the outer rotor rotating in a counter direction, the flung sand will have a very high impact force when it strikes the impact section. This high impact force causes the sand to shatter. It has been found that, under these impact conditions, reduced sand particles are obtained that have sharp edges and improved properties in a variety of applications.

To achieve an optimal result, a first sand fraction with an average particle size below a certain threshold is separated from a second sand fraction that have an average particle size above a certain threshold. This is achieved by extracting the first sand fraction by sucking the smaller sand particles from the impact crusher, while the second sand fraction falls to a collector under the influence of gravity.

The sand particles of the separated first sand fraction have been shown to have advantageous properties in a variety of applications, including but not limited to soil improvement agents, artificial fertilizer, self-levelling mortar.

### Soil Improvement Agent

### Method

In the Dordtsche Biesbosh, potatoes are grown on fields that have a clay soil. Impact reduced sand particles of a first sand fraction that have been produced with the method according to the invention have been added to parts of these field to study the effect on the yield and quality of grown potatoes.

An amount of the impact reduced sand was added to four 10 m² test fields before sowing of the plant seeds. A fifth test field of 10 m² was used as a reference test field to compare the results of the four test fields. Fertilizer was used on each of the five test fields according to standard procedures. In Table 1 an overview is provided of each of the five test fields and the amount of sand used thereon:

TABLE 1
Amount of impact reduced sand used on test fields A-E.

| | Amount of sand | Total amount of |
|---|---|---|
| Test field | used (kg/m²) | sand used (kg) |
| A | 1 | 10 |
| B | 0.5 | 5 |
| C | 0.1 | 1 |
| D | 0.05 | 0.5 |
| E (ref.) | 0 | 0 |

### Results

The potatoes of each test field were harvested after three months. These harvested potatoes were evaluated for the yield in kg, potato size, skin quality ranking from 1-10, baking quality ranking from 1-20. In addition, the average number of stems on each plant is reviewed. The results are shown in the following Table 2:

TABLE 2
Test fields A-E results for yield, potato size, skin
quality, baking quality, and number of stems.

| | | Potatoes | Potatoes | | | |
|---|---|---|---|---|---|---|
| | | larger | larger | | | |
| Test | Yield | than 40 | than 65 | Skin | Baking | Number |
| field | (kg) | mm (%) | mm (%) | quality | quality | of stems |
| A | 8.65 | 97 | 30 | 7 | 19 | 4-5 |
| B | 9.44 | 96 | 28 | 7 | 20 | 3 |
| C | 9.81 | 94 | 25 | 7 | 19 | 3 |
| D | 9.50 | 96 | 21 | 7 | 20 | 3 |
| E (ref.) | 7.42 | 92 | 19 | 7 | 19 | 3 |

The results show that fields A-D have an improved potato yield, both in total amount of kg of potatoes as well as in the size of the potatoes that have been harvested, compared to the reference test field. Higher yields were measured on each field to which the impact reduced sand was applied. In addition, an improvement in average potato size is seen on the test fields with sand added thereto, with an increase in sand also leading to an increase in average potato size. These improvements in yield and size do not detract from skin quality and baking quality, which remain constant on each test field compared to the reference test field.

It has furthermore been found that the potato plants of test fields A-D have less stems than the potato plants on reference test field E. The reference test field E has an average of 4-5 stems per plant, while the test fields A-D with sand added thereto only have an average of 3 stems. In addition thereto, but not shown in the table, it is noted as an observation that there are fewer leaves on the plants of test fields A-D. Both the reduced number of stems and leaves may indicate better uptake of nutrients by the plant. Because of the improved uptake of nutrients the plant requires less stems to extract sufficient nutrients from the soil.

An advantage of this reduced number of stems is that less energy is required during harvesting destroy the stems.

It is also noted that a large amount of soil life was found in test fields A-D, and the potatoes emerged cleaner from the soil. This may indicate that water is more easily attracted by the soil with impact reduced sand, and the soil is more aerated.

Although in this test example the sand is used to improve potato yields, the use of the sand extends much further. It is expected that virtually every crop or plant. can benefit from the use of the sand.

### Fertilizer

Two trials were conducted on fields of grassland to study the effect of impact reduced sand on the properties of grass. In each trial, there is one reference field on which artificial fertilizer was used according to standard procedure, and one field on which only impact reduced sand was used (and thus no artificial fertilizer). Quantities of the used impact reduced sand an fertilizer used in tests 1 and 2 is shown in table 3.

TABLE 3
Artificial fertilizer and impact reduced sand used in test 1 and 2.

| | |
|---|---|
| Test 1 | Test 2 |

| Field | Fertilizer | Field | Fertilizer |
|---|---|---|---|
| 1A | Artificial fertilizer | 2A | Artificial fertilizer |
| 1B | 1000 kg sand | 2B | 500 kg sand |

Additional test 3 was conducted on the fields 1A and 1B of test 1, after harvesting of the grass that was grown during test 1. This test was conducted to investigate the duration of the effect of the impact reduced sand. In test 3, artificial fertilizer was again used on field 1A according to standard procedures. Nothing however was used on field 1B (thus no impact reduced sand and/or artificial fertilizer). Quantities of artificial fertilizer used in test 3 are shown in table 4.

Test 4. Artificial fertilizer used in test 3.
Test 3

| Field | Fertilizer |
|---|---|
| 3A (previous 1A) | Artificial fertilizer |
| 3B (previous 1B) | — |

### Results

Bales of grass of each field has been tested on the Feed Unit Milk (FUM) and the content of crude ash, crude protein total, nitrogen and phosphorus.

Feed Unit Milk (FUM) is an energy parameter for dairy farmers. It represents the net energy content of a product for lactating cows.

Crude ash is the inorganic portion of organic matter. It is often associated with sand but can also be minerals that have not been fully converted to organic matter.

Crude protein is the protein that is readily available in the grass. It has a direct relationship with milk production, as well as with urea and protein levels. Sufficient (>145 g/kg dry matter) crude protein is the basis of good milk production.

Nitrogen (N) is the most important nutrient for the growth and development of crops. It is a building block for proteins, plays an important role in cell division, and is a component of enzymes, chlorophyll and DNA. A nitrogen deficiency manifests itself directly in poorer growth and a light color of the grass. An excess of nitrogen entails a high protein content that is not in proportion with the energy value. This results in the loss of nitrogen through urine.

Phosphorus is required in substantial amounts by high-producing dairy. The usual rule of thumb is that 1 kg of milk contains one gram of phosphorus, upon which additional requirements can be estimated.

Based on these tests the influence of the impact reduced sand on nutrient uptake can be determined. The results for the above mentioned nutritional values for the fields 1A-3B are shown in Table 5.

TABLE 5
Test results for test fields 1A-3B.

| | Desired | Test 1 | | Test 2 | | Test 3 | |
|---|---|---|---|---|---|---|---|
| Nutritional value | value | 1A | 1B | 2A | 2B | 3A | 3B |
| Feed Unit Milk | 830-890 | 883 | 888 | 890 | 904 | 703 | 684 |
| Crude ash (g/kg) | 90-120 | 98 | 113 | 136 | 112 | 202 | 234 |
| Crude protein total | 150-190 | 124 | 151 | 183 | 182 | 207 | 215 |
| (g/kg) | | | | | | | |
| Nitrogen (g/kg) | | 19.8 | 24.1 | 29.3 | 29.2 | 33.2 | 34.4 |
| Phosphorous (g/kg) | 3.0-4.5 | 2.6 | 2.8 | 2.5 | 3.0 | 2.6 | 2.7 |

The results in table 5 show that the test results for the bales of gras from test fields 1B, 2B (on which only impact reduced sand was used) and 3B (having nothing used thereon), are at least as good as and sometimes even better than the test results for the bales of gras from test fields 1A, 2A and 3A (on which only artificial fertilizer was used)

For test 1, all nutritional values of test field 1B show improvements over test field 1A. Particularly the crude protein total and the nitrogen content, which are the most important nutritional values, are significantly higher for test field 1B than for test field 1A. One explanation for these improvements may be that the sand provides enhanced uptake of nutrients, such as nitrogen, by the roots of the grass.

Tests 2 and 3 shows similar results for test fields 2A and 2B and for 3A and 3B. From this it can be concluded that the use of sand makes fertilizer superfluous. Moreover, in test 3, no additives (artificial fertilizer or impact reduced sand) was used on test field 3B, while the test results for test field 3B are slightly better than the test results for test field 3A, on which artificial fertilizer was used. It follows from these test results that the effect of the impact reduced sand in the soil lasts for a very long time. So the application of impact reduced sand on the fields may be done at a lower frequency than the application of artificial fertilizer.

The benefits of the used of impact reduced sand on grass are two-fold: first, the test results show clear advantages of the use of impact reduced sand on the nutritional content of grass, due to a better uptake of the nutrients. Second, the use of impact reduced sand is better for the environment compared to artificial fertilizers. The impact reduced sand improves the uptake of natural occurring nutrients in the soil, without requiring additional nutrients to be added into the soil. This in contrast to artificial fertilizer, which adds nutrients of non-organic origin into the soil to promote the growth of plants and crops. It is a well-known disadvantage of artificial fertilizers that an excessive amount of nutrients, such as nitrogen and phosphorus, have adverse ecological effects, such as the pollution of water. When using impact reduced sand these disadvantages of fertilizer are avoided without compromising the growth and quality of plants, and optionally even improving the growth and quality of plants.

The improved plant characteristics may also be (partially) explained by the additional surface adsorbed CO₂ due to the mechanochemical surface activation. In the soil, the concentration of CO₂ can be influenced by various factors, such as microbial activity, organic matter decomposition, and root respiration. Under certain conditions, increased CO₂ levels in the soil can also positively affect plant growth. The presence of higher CO₂ levels in the soil can enhance root development and root activity, leading to improved nutrient uptake and water absorption by plants. This, in turn, can contribute to overall plant growth and productivity.

### Self-Leveling Mortar

### Method

The properties of a modified mortar comprising impact reduced sand as well as a reference mortar have been tested. For the preparation of both mortars, Atlas SMS 30 mortar, which is based on cement, was used.

The compositions of both the reference mortar as well as of the modified mortar are shown in Table 6. The reference mortar comprises no impact reduced sand and a higher quantity of water, compared to the modified mortar. Both mortars were mixed for 3 minutes with a drill spindle before executing the tests. All tests were conducted under laboratory conditions at 20° C. and 65% relative humidity. Test results include the flow behavior, strength development, and shrinkage of the impact reduced mortar and the reference mortar.

TABLE 6
Compositions of the reference mortar and the
modified mortar having impact reduced sand.

| Reference mortar | Modified mortar |
|---|---|
| 1000 g Atlas SMS 30 | 650 g Atlas SMS 30 |
| 0 g impact reduced sand | 350 g impact reduced sand |
| 220 g water | 180 g water |

### Results

All test results for the reference mortar and modified mortar are shown in Table 7.

TABLE 7
Test results for reference mortar and modified
mortar comprising impact reduced sand

| | | | | Reference | Modified | |
|---|---|---|---|---|---|---|
| Properties | | | Unit | mortar | mortar | Effect |
| Volumetric mass | | | kg/m3 | 2094 | 2138 | Heavier |
| Air content | | | % | 0.5 | 1.0 | Higher air content |
| Temperature after | | | ° C. | 23.0 | 22.7 | |
| mixing | | | | | | |
| Flow | 5 | minutes | mm | 48-68 | 54->82 | Improved flow |
| | 15 | minutes | mm | 41-57 | 47-74 | Improved flow |
| | 30 | minutes | mm | 41-56 | 44-70 | Improved flow |
| | 45 | minutes | mm | 31-44 | 39-66 | Improved flow |
| | 60 | minutes | mm | 29-39 | 36-64 | Improved flow |
| Ontmenging | | | | — | — | No difference |
| Volumetric mass | 24 | hours | kg/m3 | 2031 | 2109 | Heavier |
| | 7 | days | kg/m3 | 2056 | 2095 | Heavier |
| | 28 | days | kg/m3 | 1850 | 1897 | Heavier |
| Flexural strength | 24 | hours | MPa | 1.7 | 1.2 | Weaker |
| | 7 | days | MPa | 2.6 | 1.9 | Weaker |
| | 28 | days | MPa | 8.0 | 6.5 | Weaker |
| Compressive | 24 | hours | MPa | 11.2 | 6.6 | Weaker |
| strength | | | | | | |
| | 7 | days | MPa | 14.2 | 8.7 | Weaker |
| | 28 | days | MPa | 29.5 | 23.1 | Weaker |
| Shrinkage | 24 | hours | mm/m | 0.03 | 0.06 | Undergoes greater |
| | | | | | | shrinkage |
| | 7 | days | mm/m | 0.30 | 0.39 | Undergoes greater |
| | | | | | | shrinkage |
| | 28 | days | mm/m | 0.73 | 0.51 | Undergoes less |
| | | | | | | shrinkage |
| Moisture loss | 24 | hours | % m/m | 7.2 | 7.7 | More moisture loss |
| | 7 | days | % m/m | 9.4 | 9.5 | More moisture loss |
| | 28 | days | % m/m | 10.4 | 9.9 | Less moisture loss |

From the test results it is evident that the addition of the impact reduced sand to the mortar notably improves the flow behavior of the mixture. The end of flow characteristic is significantly better in the modified product. Replacing Atlas SMS 30 with the impact reduced sand reduces the cement content in the mixture, resulting in lower water demand. This reduction is compensated for by using less water in the modified product.

Self-leveling mortars often utilize spherical particles that function as ball bearings, enhancing fluidity. However, the impact reduced sand does not conform to this shape; they are sharp, splinter-like particles with an irregular grain size distribution. It is furthermore hypothesized that surface adsorbed CO₂ may influence the flow characteristics of the mortar through the carboxylation reaction, in which water is formed. When the mortar is mixed, a carboxylation reaction takes place between specific constituents in the mortar and CO₂. This reaction is one of the mechanisms responsible for the carbonation process of the mortar. Carbonation is a common phenomenon associated with cementitious materials, such as self-leveling mortar, where CO₂ reacts with the alkaline components, typically calcium hydroxide (Ca(OH)2), found in the mortar's cementitious binder. As a result of this reaction, calcium carbonate (CaCO3), a solid mineral compound, is formed. The general chemical equation for the carboxylation (carbonation) reaction in self-leveling mortar is as follows:

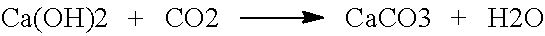

The reaction between carbon dioxide and calcium hydroxide yields calcium carbonate and water. According to the inventors of the present invention, it is hypothesized that the surface-adsorbed CO₂ reacts with the calcium hydroxide, leading to the generation of water. This additional water may be the factor contributing to the improved flow of the mortar.

The modified product contains 35% less binder due to the addition of 0.35 kg of impact reduced sand. As a result, the early compressive and flexural strength of the modified product are notably weaker, with reductions of 29% and 41% after 24 hours, respectively. However, these weaknesses are partially compensated after 28 days, with compressive and flexural strength being 19% and 22% weaker, respectively.

The reference mortar complies with the declared strength class of C30 for compressive strength and strength class F7 for flexural strength (according to EN 13813) after 28 days. With the addition of the impact reduced sand, the modified mortar falls two classes lower: C20 for compressive strength and F6 (possibly F7, depending on rounding) for flexural strength. While this should not pose a problem for floor levelling, it does mean that the floor is more susceptible to damage in the early stage, such as from falling objects.

During the initial stage, the modified product shows a slightly higher level of shrinkage. However, after 28 days, this difference is balanced, and the modification demonstrates significantly less shrinkage compared to the base product. The same goes for the moisture loss: in the early phase, the modified mortar experiences a slightly higher moisture loss compared to the reference mortar. However, after 28 days, the situation reverses, and the moisture loss becomes 4% less compared to the reference mortar.

### BRIEF DESCRIPTION OF THE DRAWINGS

The invention shall now be explained in more detail below by means of describing some exemplary embodiments in a non-limiting way with reference to the accompanying drawings, in which:

FIG. 1 shows, schematically, a cross-section of an impact crusher according to an embodiment of the invention;

FIG. 2 shows an impact crusher according to an embodiment of the invention;

FIG. 3 shows an inner rotor of an impact crusher according to an embodiment the invention;

FIG. 4 shows, schematically, shows the separation mechanisms for separating mineral particles;

FIG. 5 shows an optical microscope photograph of impact reduced sand particles;

FIG. 6 shows a SEM photograph of impact reduced sand particles;

### DETAILED DESCRIPTION OF THE DRAWINGS

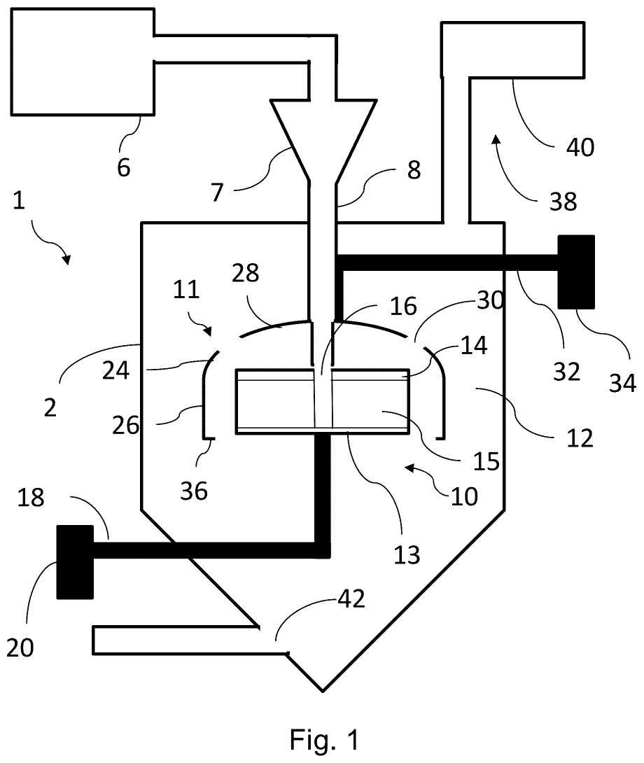

In FIG. 1, schematically, an impact crusher according to the invention is shown that has been given the reference numeral 1. The impact crusher 1 comprises a housing 2. Mineral particles 4 are stored in a mineral storage 6 before being fed to the impact crusher 1. The mineral storage may also function as a drying system for drying the mineral particles before these are fed to the impact crusher.

The mineral storage 6 feeds mineral particles to a dosing system 7, such as a silo or silo bin, before the mineral particles enter the housing 2 of the impact crusher 1. Feeding of the mineral particles from the mineral storage 6 to the dosing system 7 may be done using varies types of transportation or conveyer means, such as screw, belt or bucket conveyers. The dosing system 7 may guide mineral particles into the housing 2 of the impact crusher 1. The dosing system 7 preferably comprises a mineral supply tube 8 through which mineral particles may fall onto the inner rotor under the influence of gravity. An inner rotor 10 and outer rotor 11 are provided within the housing 2. Between the housing and the outer rotor, a discharge space 12 is present. In this embodiment, the inner rotor 10 comprises a circular bottom plate 13 and a circular top plate 14 with vanes 15 provided in between the bottom plate 13 and top plate 14. A top plate 14 is not necessarily required but can be beneficial in preventing mineral from shooting away in undesired directions, i.e. in other directions than towards the outer rotor 11. The bottom plate 13 preferably comprises a central opening 16 for receiving the mineral particles. The inner rotor 10 is configured for rotating in a first rotation direction around its central axis that is substantially vertical. The bottom plate 13 of the inner rotor 10 is mounted on a first rotational drive 18. The first rotational drive 18 is driven in rotation by a motor 20.

An outer rotor 11 is provided coaxially with the inner rotor within the housing 2. The outer rotor 11 comprises a circumferential wall 24 having an impact section 26. A cover 28 is provided on an axial side of the outer rotor 11. The outer rotor 11 is driven in rotation through the cover 28. Apertures 30 are provided within the cover 28. The outer rotor 22 is mounted on a second rotational drive 32. This second rotational drive is driven in rotation by a motor 34, which in this embodiment is a different motor from the first motor 20, but alternatively one motor may be used for driving both of the drives 18, 32.

The inner and outer rotor 10, 11 are configured for counter rotating around the central axis. When the inner rotor 10 is driven in rotation, mineral particles that are dropped on the inner rotor 10 move under the influence of a centrifugal force towards an outer edge of the inner rotor 10. The mineral particles are then flung in a tangential direction from the outer edge of the inner rotor 10 at high speed, and afterwards strike the impact section 26 of the circumferential wall 24 of the outer rotor 11. Upon impact, the mineral particles are reduced in size. According to the inventive thought, impact reduced mineral particles may exit the outer rotor 11 through either axial sides of the impact section 26, i.e. upwards and downwards of the impact section in the embodiment of the vertical impact crusher. The impact reduced mineral particles may for example be removed from the outer rotor 11 through the apertures 30 in the cover 28 of the outer rotor 11 and through an open bottom of the outer rotor 11. Due to this two-sided removal, the inner and outer rotors 10, 11 can achieve a very high speed without jamming due to, for example, the build-up of a thick layer of mineral particles between the two rotors that would cause them to rub against each other. As a result, the rotational speed may be further increased, thereby increasing the impact with which the particles impact the impact section 26 and allowing for further size reduction to occur. When the impact crusher 1 is in use, the inner rotor 10 and the outer rotor 11 preferably counter-rotate with a velocity difference of at least 5000 rpm, and more preferably with a velocity difference of at least 6000 rpm. This significant difference in velocity further increases the impact force of the mineral particles onto the impact section 26. It is preferred that inner 10 and outer rotor 11 rotate with a similar velocity in opposite directions. For example, when the velocity difference between the inner 10 and outer rotor 22 is 6000 rpm, the inner rotor 10 rotates with 3000 rpm in the first rotation direction, while the outer rotor 22 rotates with 3000 rpm in the second rotation direction. This allows the greatest impact force in the most efficient manner.

The circumferential wall 24 of the outer rotor 11 comprises an inward protrusion 36 at a bottom end of the circumferential wall 24. Advantageously, the protrusion 36 allows mineral to form an impact belt on the circumferential wall 24 of the outer rotor 22 during use of the impact crusher 1. This impact belt further increases the mineral size reduction rate and prevents wear and tear of the outer rotor 22.

The impact crusher 1 further comprises a separation mechanism 38 for separating the impact reduced mineral particles in the discharge space 12 into a first mineral fraction with mineral particles that have a first average particle size below a first threshold and a second mineral fraction with mineral particles that have a second average particle size above said first threshold. The separation mechanism 38 comprises an extractor 40 that is configured for sucking the first mineral fraction of the discharged mineral particles from the discharge space 12. Simultaneously, to prevent the impact crusher from creating a vacuum, fluid (in particular air) is drawn in through an opening 42 in the housing. The extracted first mineral fraction is then discharged from the impact crusher to e.g. a vessel. The second mineral fraction, which comprises larger mineral particles relative to the first mineral fraction, fall towards the bottom of the impact crusher 1 under the influence of gravity. This fallen second mineral fraction may be discharged from the housing through an opening in a lower part of the housing, optionally the same opening 42 through which the fluid is drawn into the housing. The second mineral fraction may be stored or recycled to the inner rotor 10 for further particle size reduction.

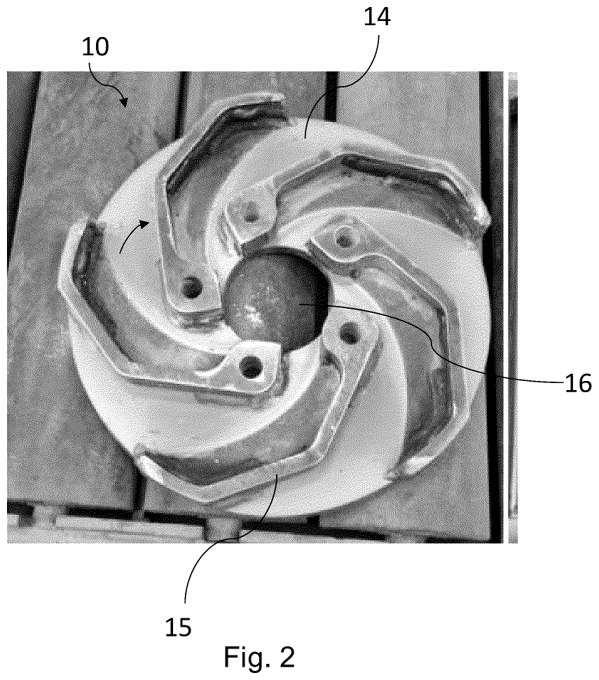

FIG. 2 shows an embodiment of a part of the inner rotor 10 according to the invention. The rotation direction of the inner rotor is shown by the arrow. In the figure a top plate 14 of the inner rotor 10 is shown. The top plate 14 has a circular shape and comprises a central opening 16 through which mineral particles may be dropped onto the bottom plate (not shown) of the inner rotor 10. Multiple vanes 15, in this embodiment five vanes, are provided between the top plate 14 and the bottom plate 12. The vanes 15 may have a variety of shapes, but in this embodiment have an angled shape, with each vane having two angles.

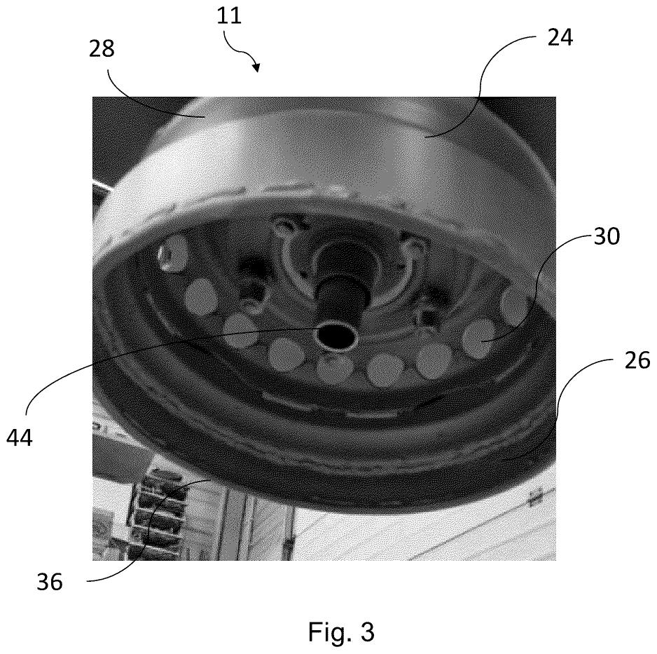

FIG. 3 shows an embodiment of an outer rotor 11 of an impact crusher 1 according to the invention. The outer rotor 11 in this embodiment is formed by a rotatable drum. The outer rotor 11 has a circumferential wall 24 with an impact section 26. At a bottom edge of the circumferential wall an inwardly extending protrusion 36 is provided. During flinging of the mineral particles and rotation of the outer rotor 22 an impact belt of collected mineral particles is formed as a result of this protrusion. This impact belt advantageously prevents wear and tear of the circumferential wall of the outer rotor 22.

The outer rotor 22 in this embodiment comprises a central opening 44 through which mineral particles are supplied to the inner rotor 10.

Openings or apertures 30 are provided in a cover 28 that is present on an upper part of the outer rotor 11. The impact reduced mineral particles may exit the outer rotor 11 through said openings or apertures 30. Moreover, impact reduced mineral particles may also exit the outer rotor 11 through the open bottom of the outer rotor 11. Due to this two-sided removal of impact reduced mineral particles from the outer rotor 11, the inner and outer rotors 10, 11 may achieve a very high rotational speed without jamming due to, for example, the build-up of a thick layer of mineral particles between the two rotors 10, 11 that would cause them to rub against each other. As a result, the rotational speed of the rotors 10, 11 may be high, which allows for optimal size reduction of the mineral particles.

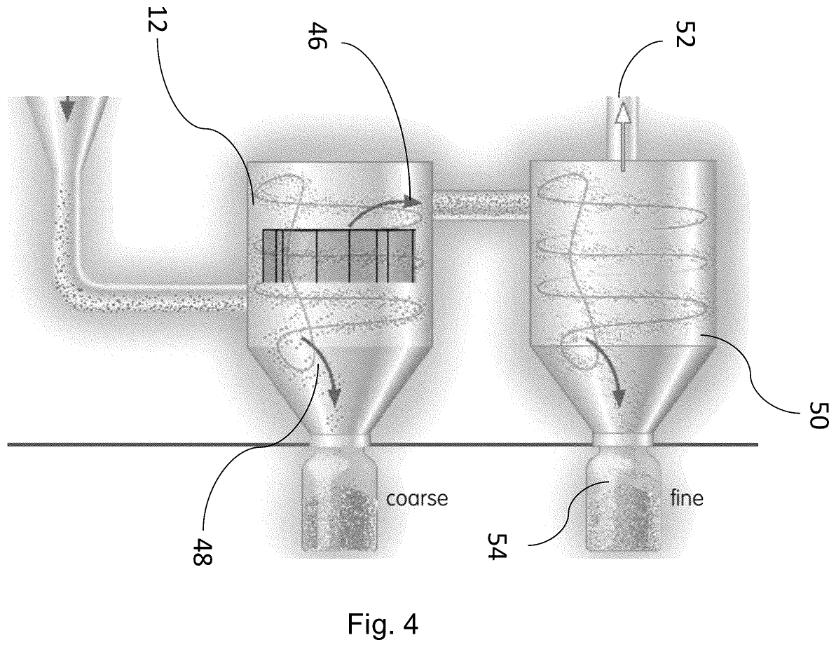

FIG. 4 schematically shows the separation of mineral particles. Mineral particles that have been flung from the inner rotor 10 to the outer rotor 11 and end up in the discharge space 12 are separated into a first mineral fraction 46 of mineral particles with an average particle size and/or weight below a first threshold value from a second mineral fraction 48 of mineral particles with an average particle size and/or weight above the first threshold value. The first mineral fraction is collected in an air classifier 50. In the air classifier 50, the first mineral fraction 46 is separated in a third mineral fraction 52 having a third average particle size and/or weight below a second threshold value and a fourth mineral fraction 54 having a fourth average particle size and/or weight above said second threshold value. Due to this second separation step, the obtained third mineral fraction 52 has a smaller particle size and/or weight distribution compared to the first mineral fraction 38, and the average particle size is smaller. The fourth mineral fraction 54 is preferably recirculated to the inner rotor for further size reduction.

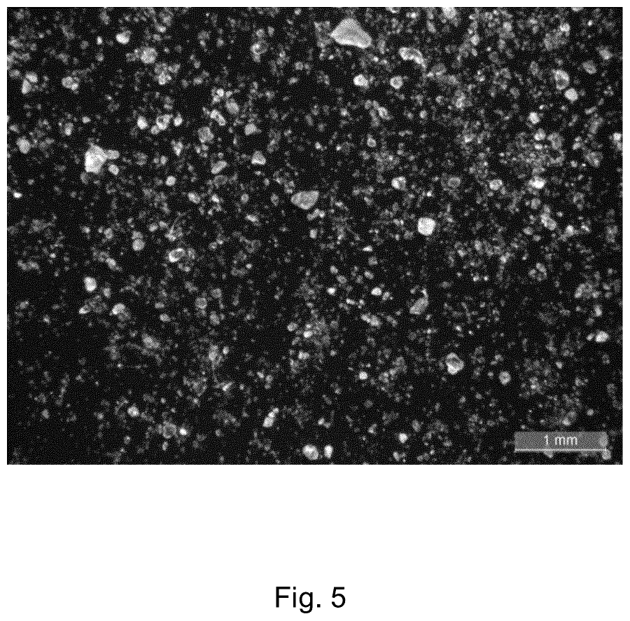

FIG. 5 shows optical microscope photograph of the first mineral fraction of impact reduced silver sand particles which are reduced with the method and impact crusher according to the invention.

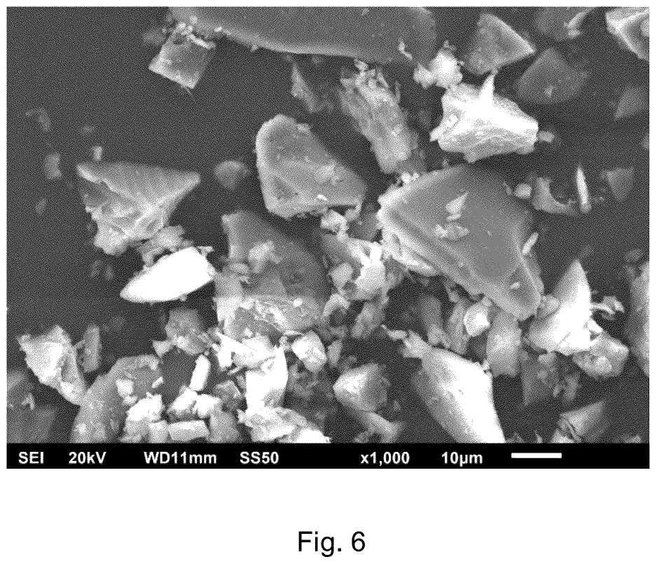

FIG. 6 shows a SEM photograph of the first mineral fraction of impact reduced silver sand particles which are reduced with the method and impact crusher according to the invention.

1. A method for reducing the size of mineral particles, comprising the steps of
providing an impact crusher comprising a housing with therein provided a rotatable inner rotor having a central axis and a rotatable outer rotor provided coaxial with the inner rotor, the outer rotor comprising a circumferential wall having an impact section, wherein a discharge space is provided between the outer rotor and an inner surface of the housing;
supplying mineral particles to the inner rotor while the inner and outer rotor counter-rotate around the central axis;
displacing the mineral particles over the inner rotor under the influence of a centrifugal force and flinging of the displaced mineral particles from the inner rotor in a tangential direction towards the impact section of the outer rotor for reducing the size of the mineral particles upon impact, thereby obtaining impact reduced mineral particles, and
discharging the impact-reduced mineral particles from the outer rotor to the discharge space,
wherein the step of discharging the impact-reduced mineral particles comprises discharging the impact-reduced mineral particles from the outer rotor to the discharge space along opposite axial sides of the impact section of the circumferential wall.

2. The method according to claim 1, wherein an apertured cover is provided on at least one axial side of the outer rotor, and wherein a part of the impact reduced mineral particles is discharged from the outer rotor to the discharge space through the aperture(s) in the cover.

3. The method according to claim 1, wherein the method further comprises the step of separating the discharged impact reduced mineral particles in at least a first mineral fraction having an average particle size and/or weight below a first threshold value and a second mineral fraction having a second average particle size and/or weight above said first threshold value.

4. The method according to claim 3, wherein the step of separating the discharged mineral particles comprises sucking the first mineral fraction from the discharge space while simultaneously drawing a fluid, in particular air, into the housing.

5. The method according to claim 3, further comprising separating the collected first mineral fraction in a third mineral fraction having an third average particle size and/or weight below a second threshold value and a fourth mineral fraction having a fourth average particle size and/or weight above said second threshold value.

6. The method according to claim 1, further comprising providing a continuous flow of a fluid, in particular air, into and out of the housing.

7. The method according to claim 1, wherein the mineral particles are flung from the inner rotor with a velocity of at least 40 m/s, preferably at least 55 m/s, more preferably at least 70 m/s.

8. The method according to claim 1, wherein the inner rotor rotates with a velocity of at least 2000 rpm, preferably at least 2500 rpm, and more preferably with at least 3000 rpm, and/or wherein the inner rotor and the outer rotor counter-rotate with a velocity difference of at least 4000 rpm, preferably at least 5000 rpm, more preferably at least 6000 rpm.

9. The method according to claim 1, wherein during flinging of the mineral particles the particles are collected on the circumferential wall and thereby form an impact belt on at least the impact section of the circumferential wall.

10.-12. (canceled)

13. An impact crusher for reducing the size of mineral particles, comprising
a rotatable inner rotor having a central axis;
a rotatable outer rotor provided coaxial with the inner rotor and comprising a circumferential wall having an impact section, wherein the inner and outer rotor are configured for during use counter-rotating around the central axis;
a housing with therein provided the inner and outer rotor and having a discharge space between an inner surface of the housing and the outer rotor, and
a mineral particle supply configured for supplying mineral particles to the inner rotor;
wherein the inner rotor is configured for during use flinging supplied mineral particles in a tangential direction from the inner rotor to the impact section of the counter-rotating outer rotor for reducing the size of the mineral particles upon impact, and
wherein the outer rotor is configured for during use discharging the impact-reduced mineral particles from the outer rotor to the discharge space along opposite axial sides of the impact section of the circumferential wall.

14. The impact crusher according to claim 13, wherein an apertured cover is provided on at least one axial side of the outer rotor.

15. The impact crusher according to claim 13, further comprising a first separation mechanism that is configured for separating discharged impact reduced mineral particles in at least a first mineral fraction having an average particle size and/or weight below a first threshold value and a second mineral fraction having an average particle size and/or weight above said first threshold value.

16. The impact crusher according to claim 15, wherein the first separation mechanism is configured for sucking the first mineral fraction from the discharge space in the housing and for simultaneously drawing a fluid, in particular air, into the housing.

17. The impact crusher according to claim 16, wherein the housing is provided with an opening at a lower part of the housing for during use drawing the fluid into the housing and discharging the second mineral fraction out of the housing through said opening, and wherein preferably louver slots are provided at said opening.

18. The impact crusher according to claim 15, further comprising a second separation mechanism for separating the first mineral fraction in at least a third mineral fraction having an average particle size and/or weight below a second threshold value and a fourth mineral fraction having an average particle size and/or weight above said second threshold value, wherein the second separation mechanism is preferably an air classifier.

19. (canceled)

20. The impact crusher according to claim 13, wherein an inwards protrusion is provided at a lower part of the circumferential wall for during use collecting flung mineral particles on at least the impact section and thereby forming a mineral particle impact belt.

21. The impact crusher according to claim 13, wherein the inner rotor is configured for rotating at a velocity of at least 2000 rpm, preferably at least 2500 rpm and more preferably at least 3000 rpm, and/or wherein the inner rotor and the outer rotor are configured for counter-rotating with a velocity difference of at least 4000 rpm, preferably at least 5000 rpm, more preferably at least 6000 rpm.

22. The impact crusher according to claim 13, wherein the housing has a polygonal shape in cross-section.

23. The impact crusher according to claim 13, wherein vanes, preferably angled vanes, are provided on the inner rotor.

24.-26. (canceled)
